(19) United States
(12) Patent Application Publication
(10) Pub. No.: US 2013/0304421 A1
(43) Pub. Date: Nov. 14, 2013

(54) REMOTE MONITOR SYSTEM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: GUANG-FENG OU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/795,535

(22) Filed: Mar. 12, 2013

(30) Foreign Application Priority Data
May 11, 2012 (CN) 201210145461.9

(51) Int. Cl. G05B 23/02

(52) U.S. Cl. CPC G05B 23/02
USPC 702/188

(57) ABSTRACT

A remote monitor system for monitoring working status of a household electronic device includes a wireless control module, an audio input module, a monitor module, and an audio output module. The wireless control module receives a remote control signal. The audio input module receives a first audio signal. The wireless control module and the audio input module convert the first audio signal and the first audio signal to digital signals respectively. The monitor module receives the digital signals, and output instruction signals to the household electronic device for corresponding operations accordingly. The monitor module detects working status of the household electronic device, and outputs working status signals accordingly. The audio output module receives the working status signals, and converts the working status signals to a second audio signal.

### BACKGROUND

1. Technical Field

The present disclosure relates to a remote monitor system for household electronic devices.

2. Description of Related Art

Digital technology has developed rapidly and spread through various areas of daily lives since the 1990s. As telecommunication networks are introduced into households, it becomes necessary to integrate electronic products and various communication means. Intelligent information products are progressively changing lifestyles of families and society. For example, intelligent home appliances such as security systems are becoming fashionable because the advantages such as safety, convenience, high efficiency, and high speed. Remote controlling of products in the home has become a popular field of research. Radio frequency identification (RFID) is a means of remote and automatic identification of a target such as an object or even an animal. RFID uses radio frequency signals to transmit information via space coupling, and thereby achieves identification. No known integration system capable of incorporating a telecommunication network with RFID for remote monitoring and controlling of the operations of home items such as doors, windows and electrical appliances.

Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a remote monitor system; the remote monitor system includes a wireless control module, an audio input module, a monitor module, and an audio output module.

FIG. 2 is a circuit diagram of the remote monitor system of FIG. 1.

FIG. 3 is a circuit diagram of the audio output module of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

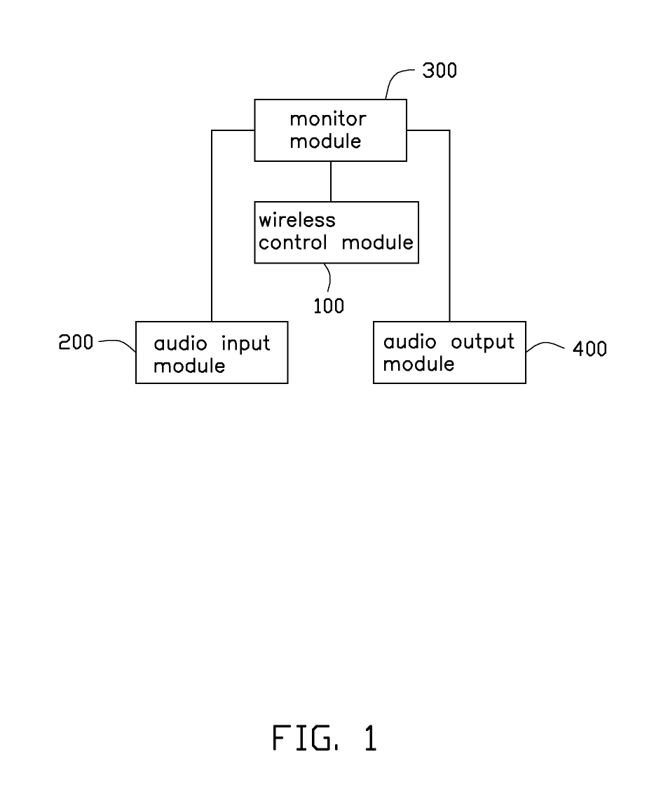

FIG. 1 illustrates a block diagram of a remote monitor system in accordance with one embodiment. The remote monitor system is used for monitoring working status of household electronic devices. The remote monitor system includes a wireless control module 100, an audio input module 200, a monitor module 300, and an audio output module 400. The wireless control module 100 receives a remote control signal. The audio input module 200 receives a first audio signal. The wireless control module 100 and the audio input module 200 convert the first audio signal and the first audio signal to digital signals, respectively. The monitor module 300 receives the digital signals, and outputs instruction signals to the household electronic devices for corresponding operations accordingly. The monitor module 300 detects working status of the household electronic devices, and outputs working status signals accordingly. The audio output module 400 receives the working status signals, and converts the working status signals to a second audio signal.

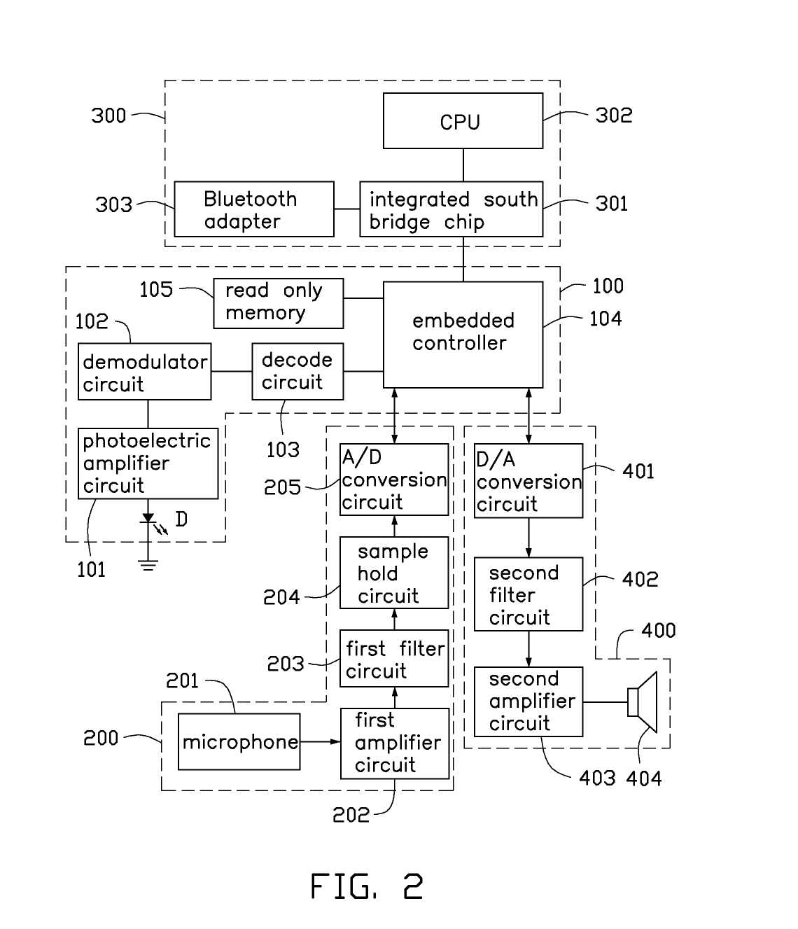

FIG. 2 illustrates a circuit diagram of the remote monitor system in accordance with one embodiment. The wireless control module 100 includes a LED D, a photoelectric amplifier circuit 101, a demodulator circuit 102, a decode circuit 103, an embedded controller 104, and a read only memory 105. The LED D receives the remote control signal, and converts the remote control signal to an electronic signal. The photoelectric amplifier circuit 101 receives the electronic signal from the LED D, and outputs an amplified electronic signal. The demodulator circuit 102 receives the amplified electronic signal, and demodulates the amplified electronic signal to a digital signal. The decode circuit 103 decodes the digital signal from the demodulator circuit 102 and transmits the decoded digital signal to the monitor module 300 via the embedded controller 104. The read only memory 105 stores the second audio signal corresponding to working status of the monitor module 300.

The audio input module 200 includes a microphone 201, a first amplifier circuit 202, a first filter circuit 203, a sample hold circuit 204, and an A/D conversion circuit 205. The microphone 201 receives the first audio signal, and converts the first audio signal to an electronic signal. The first amplifier circuit 202 receives the electronic signal from the microphone 201, and outputs an amplified electronic signal. The first filter circuit 203 receives the amplified electronic signal from the first amplifier circuit 202, and outputs a filtered electronic signal. The sample hold circuit 204 receives the filtered electronic signal, and outputs a steady electronic signal. The A/D conversion circuit 205 receives the steady electronic signal, and converts the steady electronic signal to a digital signal which is transmitted to the monitor module 300 via the embedded controller 104.

The monitor module 300 includes an integrated south bridge chip 301, a CPU 302, and a Bluetooth adapter 303. The integrated south bridge chip 301 receives the digital signals from the embedded controller 104, and outputs the corresponding instruction signals via the Bluetooth adapter 303 accordingly. The CPU 302 controls the integrated south bridge chip 301 to output the instruction signals.

The audio output module 400 includes a D/A conversion circuit 401, a second filter circuit 402, a second amplifier circuit 403, and a speaker 404. The D/A conversion circuit 401 receives the working status signals from the monitor module 300 via the embedded controller 104, and converts the working status signals to the second audio signal. The second filter circuit 402 receives the second audio signal, and outputs a filtered second audio signal. The second amplifier circuit 403 receives the filtered second audio signal, and outputs an amplified second audio signal. The speaker 404 receives the amplified second audio signal, and alarms to indicate accordingly.

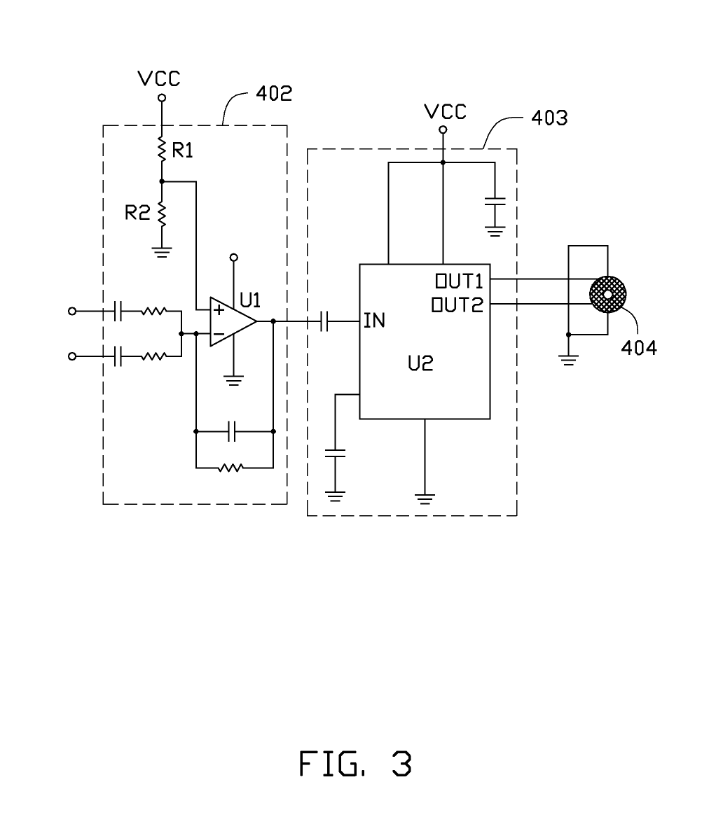

FIG. 3 illustrates a circuit diagram of the audio output module. The second filter circuit 402 includes a comparator U1, a first resistor R1, and a second resistor R2. The comparator U1 includes a non-inverting input terminal, an inverting input terminal, and an output terminal. The non-inverting input terminal of the comparator U1 receives a DC voltage via the first resistor R1. The non-inverting input terminal of the comparator U1 is grounded via the second resistor R2. The inverting input terminal of the comparator U1 receives the second audio signal. The output terminal of the comparator U1 outputs the filtered second audio signal. The second amplifier circuit 403 includes an audio amplifier chip U2. The audio amplifier chip U2 includes an audio signal input terminal IN, a first audio signal output terminal OUT1, and a second audio signal output terminal OUT2. The audio signal input terminal IN of the audio amplifier chip U2 is electrically connected to the output terminal of the comparator U1 to receive the filtered second audio signal. The first audio signal output terminal OUT1 and the second audio signal output terminal OUT2 of the audio amplifier chip U2 are electrically connected to the speaker 404 to output the amplified second audio signal. In one embodiment, the DC voltage is +5V.

In application, the microphone 201 receives the first audio signal. The first audio signal is amplified by the first amplifier circuit 202, filtered by the first filter circuit 203, held by the sample hold circuit 204, and A/D converted by the A/D conversion circuit 205 to the digital signal. The embedded controller 104 transmits the digital signal corresponding to the first audio signal to the integrated south bridge chip 301. The integrated south bridge chip 301 outputs instruction signals to the household electronic devices for corresponding operations via the Bluetooth adapter 303.

The LED D receives the remote control signal. The remote control signal is amplified by the photoelectric amplifier circuit 101, demodulated by the demodulator circuit 102, and decoded by the decode circuit 103 to the digital signal. The embedded controller 104 transmits the digital signal corresponding to the remote control signal to the integrated south bridge chip 301. The integrated south bridge chip 301 outputs instruction signals to the household electronic devices for corresponding operations via the Bluetooth adapter 303.

The monitor module 300 outputs the working status signals according to working status of the household electronic devices. The working status signals of the household electronic devices are D/A converted by the D/A conversion circuit 401, filtered by the second filter circuit 402, and amplified by the second amplifier circuit 403 to the second audio signal. The speaker 404 receives the second audio signal, and alarms to indicate working status of the corresponding household electronic devices. The monitor module 300 outputs working status signals according to working status of the integrated south bridge chip 301 and the CPU 302. The working status signals of the integrated south bridge chip 301 and the CPU 302 are D/A converted by the D/A conversion circuit 401, filtered by the second filter circuit 402, and amplified by the second amplifier circuit 403 to the second audio signal. The speaker 404 receives the second audio signal, and alarms to indicate working status of the monitor module 300.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A remote monitor system for monitoring working status of a household electronic device comprising:
a wireless control module adapted to receive a remote control signal;
an audio input module adapted to receive a first audio signal; wherein the wireless control module and the audio input module convert the first audio signal and the first audio signal to digital signals respectively;
a monitor module adapted to receive the digital signals, and output instruction signals to the household electronic device; wherein the monitor module detects working status of the household electronic device, and outputs working status signals accordingly; and;
an audio output module adapted to receive the working status signals, and convert the working status signals to a second audio signal.

2. The remote monitor system of claim 1, wherein the wireless control module comprises a LED, a demodulator circuit, a decode circuit, and an embedded controller; the LED receives the remote control signal, and converts the remote control signal to an electronic signal; the demodulator circuit receives the electronic signal from the LED, and demodulates the electronic signal to a digital signal; and the decode circuit decodes the digital signal from the demodulator circuit and transmits the decoded digital signal to the monitor module via the embedded controller.

3. The remote monitor system of claim 2, wherein the wireless control module further comprises a photoelectric amplifier circuit and a read only memory; the photoelectric amplifier circuit receives the electronic signal from the LED, and outputs an amplified electronic signal to the demodulator circuit; and the read only memory stores the second audio signal corresponding to working status of the monitor module.

4. The remote monitor system of claim 3, wherein the audio input module comprises a microphone, a sample hold circuit, and an A/D conversion circuit; the microphone receives the first audio signal, and converts the first audio signal to an electronic signal; the sample hold circuit receives the electronic signal from the microphone, and outputs a steady electronic signal; and the A/D conversion circuit receives the steady electronic signal, and converts the steady electronic signal to a digital signal which is transmitted to the monitor module via the embedded controller.

5. The remote monitor system of claim 4, wherein the audio input module further comprises a first amplifier circuit and a first filter circuit; the first amplifier circuit receives the electronic signal from the microphone, and outputs an amplified electronic signal; and the first filter circuit receives the amplified electronic signal from the first amplifier circuit, and outputs a filtered electronic signal to the sample hold circuit.

6. The remote monitor system of claim 5, wherein the monitor module comprises an integrated south bridge chip, a CPU, and a Bluetooth adapter; the integrated south bridge chip receives the digital signals from the embedded controller, and outputs the corresponding instruction signals via the Bluetooth adapter accordingly; and the CPU controls the integrated south bridge chip output the instruction signals.

7. The remote monitor system of claim 6, wherein the audio output module comprises a D/A conversion circuit and a speaker; the D/A conversion circuit receives the working status signals from the monitor module via the embedded controller, and converts the working status signals to the second audio signal; and the speaker receives the second audio signal, and alarms to indicate accordingly.

8. The remote monitor system of claim 7, wherein the audio output module further comprises a second filter circuit and a second amplifier circuit; the second filter circuit receives the second audio signal, and outputs a filtered second audio signal; and the second amplifier circuit receives the filtered second audio signal, and outputs an amplified second audio signal to the speaker.

9. The remote monitor system of claim 8, wherein the second filter circuit comprises a comparator, a first resistor, and a second resistor; the comparator comprises a non-inverting input terminal, an inverting input terminal, and an output terminal; the non-inverting input terminal of the comparator receives a DC voltage via the first resistor; the non-inverting input terminal of the comparator is grounded via the second resistor; the inverting input terminal of the comparator receives the second audio signal; and the output terminal of the comparator outputs the filtered second audio signal.

10. The remote monitor system of claim 9, wherein the second amplifier circuit comprises an audio amplifier chip; the audio amplifier chip comprises an audio signal input terminal, a first audio signal output terminal, and a second audio signal output terminal; the audio signal input terminal of the audio amplifier chip is electrically connected to the output terminal of the comparator to receive the filtered second audio signal; the first audio signal output terminal and the second audio signal output terminal of the audio amplifier chip are electrically connected to the speaker to output the amplified second audio signal.

11. A remote monitor system comprising:
a household electronic device;
a wireless control module adapted to receive a remote control signal;
an audio input module adapted to receive a first audio signal; wherein the wireless control module and the audio input module convert the first audio signal and the first audio signal to digital signals respectively;
a monitor module adapted to receive the digital signals, and output instruction signals to the household electronic device for corresponding operations accordingly; wherein the monitor module detects working status of the household electronic device, and outputs working status signals accordingly; and;
an audio output module adapted to receive the working status signals, and convert the working status signals to a second audio signal.

12. The remote monitor system of claim 11, wherein the wireless control module comprises a LED, a demodulator circuit, a decode circuit, and an embedded controller; the LED receives the remote control signal, and converts the remote control signal to an electronic signal; the demodulator circuit receives the electronic signal from the LED, and demodulates the electronic signal to a digital signal; and the decode circuit decodes the digital signal from the demodulator circuit and transmits the decoded digital signal to the monitor module via the embedded controller.

13. The remote monitor system of claim 12, wherein the wireless control module further comprises a photoelectric amplifier circuit and a read only memory; the photoelectric amplifier circuit receives the electronic signal from the LED, and outputs an amplified electronic signal to the demodulator circuit; and the read only memory stores the second audio signal corresponding to working status of the monitor module.

14. The remote monitor system of claim 13, wherein the audio input module comprises a microphone, a sample hold circuit, and an A/D conversion circuit; the microphone receives the first audio signal, and converts the first audio signal to an electronic signal; the sample hold circuit receives the electronic signal from the microphone, and outputs a steady electronic signal; and the A/D conversion circuit receives the steady electronic signal, and converts the steady electronic signal to a digital signal which is transmitted to the monitor module via the embedded controller.

15. The remote monitor system of claim 14, wherein the audio input module further comprises a first amplifier circuit and a first filter circuit; the first amplifier circuit receives the electronic signal from the microphone, and outputs an amplified electronic signal; and the first filter circuit receives the amplified electronic signal from the first amplifier circuit, and outputs a filtered electronic signal to the sample hold circuit.

16. The remote monitor system of claim 15, wherein the monitor module comprises an integrated south bridge chip, a CPU, and a Bluetooth adapter; the integrated south bridge chip receives the digital signals from the embedded controller, and outputs the corresponding instruction signals via the Bluetooth adapter accordingly; and the CPU controls the integrated south bridge chip output the instruction signals.

17. The remote monitor system of claim 16, wherein the audio output module comprises a D/A conversion circuit and a speaker; the D/A conversion circuit receives the working status signals from the monitor module via the embedded controller, and converts the working status signals to the second audio signal; and the speaker receives the second audio signal, and alarms to indicate accordingly.

18. The remote monitor system of claim 17, wherein the audio output module further comprises a second filter circuit and a second amplifier circuit; the second filter circuit receives the second audio signal, and outputs a filtered second audio signal; and the second amplifier circuit receives the filtered second audio signal, and outputs an amplified second audio signal to the speaker.

19. The remote monitor system of claim 18, wherein the second filter circuit comprises a comparator, a first resistor, and a second resistor; the comparator comprises a non-inverting input terminal, an inverting input terminal, and an output terminal; the non-inverting input terminal of the comparator receives a DC voltage via the first resistor; the non-inverting input terminal of the comparator is grounded via the second resistor; the inverting input terminal of the comparator receives the second audio signal; and the output terminal of the comparator outputs the filtered second audio signal.

20. The remote monitor system of claim 19, wherein the second amplifier circuit comprises an audio amplifier chip; the audio amplifier chip comprises an audio signal input terminal, a first audio signal output terminal, and a second audio signal output terminal; the audio signal input terminal of the audio amplifier chip is electrically connected to the output terminal of the comparator to receive the filtered second audio signal; the first audio signal output terminal and the second audio signal output terminal of the audio amplifier chip are electrically connected to the speaker to output the amplified second audio signal.
